(19) United States
(12) Patent Application Publication
(10) Pub. No.: US 2026/0009243 A1
(43) Pub. Date: Jan. 8, 2026

(54) A WIRE TYING MACHINE

(71) Applicant: HUSQVARNA AB, Huskvarna (SE)

(72) Inventors: Jonas SUNDMARK, Goteborg (SE); Jonas ERIKSSON, Knivsta (SE); Casper CHRISTIANSEN, Goteborg (SE)

(21) Appl. No.: 18/881,965

(22) PCT Filed: Jul. 5, 2023
(86) PCT No.: PCT/SE2023/050707

§ 371 Date: Jan. 7, 2025

(30) Foreign Application Priority Data
Jul. 7, 2022 (SE) 2250869-1
Jul. 7, 2022 (SE) 2250870-9

(51) Int. Cl. E04G 21/12; B25B 25/00

(52) U.S. Cl. CPC E04G 21/123; B25B 25/00

(57) ABSTRACT

The present disclosure relates to a wire tying machine (100) adapted to tie wire knots (153) that secure reinforcement bars (105, 106) together. The wire tying machine (100) comprises a lid (160, a main body part (102), a trigger (140) and a spool compartment (155) that is adapted to accommodate a wire spool 5 150 comprising a length of wire (151) behind the lid (160). The wire tying machine (100) is arranged to feed (110) a free end (152) of the wire (151) out from an opening in a tying head (101) of the wire tying machine (100). The wire tying machine (100) comprises a control unit arrangement (130) and a sensor arrangement (120), where the sensor arrangement (120) is adapted to detect if the lid (160) is in a closed position (A) or in an opened position (B), and to output a signal to the control unit arrangement (130), which signal is indicative of if the lid (160) is in the closed position (A) or in the opened position (B).

### TECHNICAL FIELD

The present disclosure relates to wire tying machines for tying reinforcement bars (rebars) together to form a rebar structure for reinforcing, e.g., concrete and other solidifiable materials.

### BACKGROUND

Concrete is strong under compression but often has relatively weak tensile strength. Reinforcing bars, or rebars, are therefore often used to strengthen concrete structures, where they significantly increase the tensile strength of the concrete.

The most common type of rebar is carbon steel, typically consisting of hot-rolled round bars with deformation patterns. Other readily available types include stainless steel, and composite bars made of glass fibre, carbon fibre, or basalt fibre. The steel reinforcing bars may also be coated in an epoxy resin designed to resist the effects of corrosion mostly in saltwater environments, but also in land-based constructions.

The rebar elements are normally connected into a rebar structure or lattice by tying the elements together with steel wire. For tying epoxy coated or galvanised rebars, epoxy coated, or galvanized wire is normally used. The wire may also be coated in plastic or the like to prevent corrosion.

Due to the large number of connection points between rebar elements in a larger rebar structure, it is desired to automate the wire tying.

EP 2666932 B1 and WO 2021086253 A1 disclose automatic rebar wire tying machines for tying rebars together. Such wire tying machines use wire on a coil or spool as a consumable part which needs to be replaced when the wire spool is empty. This wire spool is secured behind a lid to make sure it is held in place and operates correctly during the tie processes, where the lid serves as a protection for a user as well as for the wire tying machine. This lid needs to be opened when replacing the wire spool, during this time it is important that the protection for a user and the wire tying machine is maintained.

There is thus a need for improved automatic wire tying machines.

### SUMMARY

It is an object of the present disclosure to provide improved automatic wire tying machines.

This object is at least in part obtained by a wire tying machine adapted to tie wire knots that secure reinforcement bars together, where the wire tying machine comprises a lid, a main body part, a trigger and a spool compartment that is adapted to accommodate a wire spool comprising a length of wire behind the lid. The wire tying machine is arranged to feed a free end of the wire out from an opening in a tying head of the wire tying machine. The wire tying machine comprises a control unit arrangement and a sensor arrangement, where the sensor arrangement is adapted to detect if the lid is in a closed position or in an opened position, and to output a signal to the control unit arrangement. This signal is indicative of if the lid is in the closed position or in the opened position.

This means that the control unit arrangement is informed about the lid's position, and is enabled to set a certain appropriate operational state in dependence of the lid's position.

According to some aspects, in case the sensor arrangement detects that the lid has been set in the closed position, this is communicated to the control unit arrangement that is adapted to set the wire tying machine in a normal running state.

According to some aspects, when the trigger is pressed in the normal running state, the wire tying machine is arranged to feed a free end of the wire out from the opening in the tying head such that the wire extends along an arcuate path to encircle reinforcement bars which are to be tied together and is then received back in the tying head, where the wire tying machine is arranged to perform a tying procedure such that a knot is formed on the wire. For example, the wire is held and brought to rotate about a wire tying head axis, which rotation forms a knot on the wire.

This means that when the lid is detected to be in the closed position, the wire tying machine is enabled to perform normal running procedures, including tying knots.

According to some aspects, in case the sensor arrangement detects that the lid has been set in the opened position, this is communicated to the control unit arrangement that is adapted to set the wire tying machine in a reload state, such that when the trigger is pressed, the wire tying machine is arranged to feed the free end of the wire towards the tying head, but without forming a knot on the wire.

This means that the function of the trigger is different in dependence of if the lid is in the opened position or in the closed position, the same trigger having two different functional states depending on the detected position of the lid. Since no knot is tied when the sensor arrangement detects that the lid has been set in the opened position, the risk for tangling of the wire and also the risk for personal injuries during loading of a new wire spool is greatly reduced. Furthermore, since the wire tying machine is arranged to feed the free end of the wire towards the tying head when pressing in the reload state, the loading of the new wire is simplified.

According to some aspects, in case the sensor arrangement detects that the lid has been set in the opened position, this is communicated to the control unit arrangement that is adapted to set the wire tying machine in a reload state, such that the trigger is de-activated.

This means that the function of the trigger is different in dependence of if the lid is in the opened position or in the closed position, the same trigger having two different functional states depending on the detected position of the lid. Since no knot is tied when the sensor arrangement detects that the lid has been set in the opened position, the risk for tangling of the wire and also the risk for personal injuries during loading of a new wire spool is greatly reduced.

According to some aspects, the wire tying machine further comprises a separate reload trigger, where, when the reload trigger is pressed, the wire tying machine is arranged to feed the free end of the wire towards the tying head, but without forming a knot on the wire.

This means that the wire feeding can be performed by means of a separate trigger, which for example is advantageous in case the the normal trigger is de-activated.

According to some aspects, the sensor arrangement comprises a first magnet and a hall-sensor element arrangement which are adapted to be separated when the lid is brought from the closed position to the opened position. The hall-sensor element arrangement is adapted to measure a magnetic field generated by the magnet, and to output a signal to the control unit arrangement, which signal is indicative of if the lid is in the closed position or in the opened position.

This means that standard components can be used, providing reliability and low cost.

According to some aspects, the first magnet is positioned on the lid, and the hall-sensor element arrangement is mounted in a fixed position on the main body part.

This means that in the case of a wired connection to the hall-sensor element arrangement, no wires are needed to run to and from the lid.

According to some aspects, the wire tying machine comprises a first metal pad that is adapted to attract the first magnet such that the lid is adapted to be retained in the closed position by means of magnetic attraction force between the first magnet and the first metal pad.

This means that the same magnet can be used in the sensor arrangement and for retaining the lid in the closed position.

According to some aspects, the sensor arrangement comprises one or more electrical switches.

This means that many different types of components and even combinations of different types of components are conceivable for the sensor arrangement.

According to some aspects, the signal that is indicative of if the lid is in the closed position or in the opened position is constituted by the presence or absence of an electric current. According to some further aspects, when the lid is in the closed position, an electric current is output to the control unit arrangement, and when the lid is in the opened position, no electric current is output to the control unit arrangement.

This provides extra security, since if the electric current signal is interrupted by accident, the wire tying machine is set in the reload state irrespective of if the lid is in the opened positioned or in the closed position. In this manner, the risk for tangled wires and personal injuries is reduced.

According to some aspects, the signal that is indicative of if the lid is in the closed position or in the opened position is constituted by an optical signal or by digital words.

In this manner, many different options are available for communicating the signal that is indicative of if the lid is in the closed position or in the opened position.

According to some aspects, the wire tying machine further comprises a retaining clip that comprises a resilient member, an attachment member and a common member. The retaining clip is attached to the main body part such that the resilient member protrudes into the spool compartment and is adapted to be positioned between rim parts of an inserted wire spool such that an inserted wire spool is retained in the spool compartment.

This means that should the lid accidentally open, the inserted wire spool is prevented from falling out by the resilient member engaging a rim part that is closest to a bottom of the spool compartment.

According to some aspects, the retaining clip is attached to a spool compartment wall part that is comprised in the main body part, such that the retaining clip faces a mounted wire spool.

This means that the retaining clip is mounted on the side of the spool compartment wall part that faces the mounted wire spool, and is thus easily accessible.

According to some aspects, the common member is at least partly retained by a body rim that runs along and covers a periphery of the spool compartment wall part.

This means that the retaining clip is retained at the common member that faces away from the bottom of the spool compartment.

According to some aspects, the resilient member and the attachment member extend mainly parallel from the common member.

This means that the retaining clip does not unnecessarily protrude into the spool compartment.

According to some aspects, at least one of the attachment member and the common member comprises a slot that is adapted to receive a corresponding ridge formed in the spool compartment.

According to some aspects, at least one slot is formed in the attachment member, between a protrusion and a holding member. The protrusion and the holding member are comprised in the attachment member.

This provides further stability such that the retaining clip is prevented from moving across its longitudinal extension.

According to some aspects, the holding member extends at a first angle to the rest of the attachment member, towards a mounted wire spool, where the first angle lies in the interval 140°-170°. This means that the holding member follows a shape of the bottom of the spool compartment.

According to some aspects, the common member is bent such that the resilient member runs along a first plane and the attachment member runs along a second plane, and such that the resilient member and the attachment member are brought closer together. There is a second angle between the first plane and the second plane, where the second angle lies in the interval 145°-175°. This means that the retaining clip follows a shape of the spool compartment wall part.

Having the retaining clip adapted to the shape of the spool compartment interior enables the retaining clip to be securely attached without the use of further attachment means.

According to some aspects, the resilient member comprises an arcuate part with an outer periphery that is adapted to face a mounted wire spool. The arcuate part protrudes into the spool compartment such that the resilient member is adapted to be positioned between the rim parts of an inserted wire spool such that an inserted wire spool is retained in the spool compartment. This means that the wire spool can be inserted into, or removed from, the spool compartment, by only moving the wire spool with sufficient force.

According to some aspects, the resilient member comprises a handle part that extends away from the rest of the resilient member such that a user is enabled to insert a wire spool, or release an inserted wire spool, by depressing the handle part such that the resilient member clears the rim parts.

This means that the resilient member can be easily moved out of the way when a wire spool is to be inserted into, or removed from, the spool compartment. This also means that the resilient member can have any suitable shape to provide desired retaining characteristics.

There are also disclosed herein methods, computer programs, control unit arrangements, retaining clips and wire tying machines associated with the above mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example wire tying machine;

FIG. 2A shows how a lid of the wire tying machine about to be opened;

FIG. 2B shows how a lid of the wire tying machine is opened;

FIG. 3 shows how new wire spool is loaded;

FIG. 4 shows how wire is loaded and thread into the wire tying machine;

FIG. 5 shows an example of how reinforcement bars are joined by means of knots formed by the wire tying machine;

FIG. 6A shows a perspective view of the wire tying machine with the lid in a partly opened position;

FIG. 6B shows an enlarged portion of FIG. 6A;

FIG. 7 shows a perspective view of the wire tying machine with the lid in a more opened position.

FIG. 8 schematically illustrates a control unit arrangement;

FIG. 9 schematically illustrates a computer program product;

FIG. 10 shows a flowchart illustrating methods according to the present disclosure;

FIG. 11 shows a flowchart illustrating methods according to the present disclosure;

FIG. 12 shows a perspective view of the wire tying machine with the lid in an open position with a retaining clip according to a first example, where a new wire spool is about to be loaded;

FIG. 13 shows the wire tying machine in FIG. 12 with a new wire spool loaded;

FIG. 14 shows a perspective view of a retaining clip according to the first example;

FIG. 15 shows a side view of the retaining clip according to the first example;

FIG. 16 shows a top view of the retaining clip according to the first example;

FIG. 17 shows a perspective view of a spool compartment with the retaining clip according to the first example;

FIG. 18 shows an enlarged view of FIG. 16 with a wire spool loaded;

FIG. 19 shows an enlarged perspective view of the retaining clip in the spool compartment;

FIG. 20 shows a perspective view of a retaining clip according to a second example;

FIG. 21 shows a perspective view of the spool compartment with the retaining clip according to the second example; and

FIG. 22 shows another perspective view of the spool compartment with the retaining clip according to the second example.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

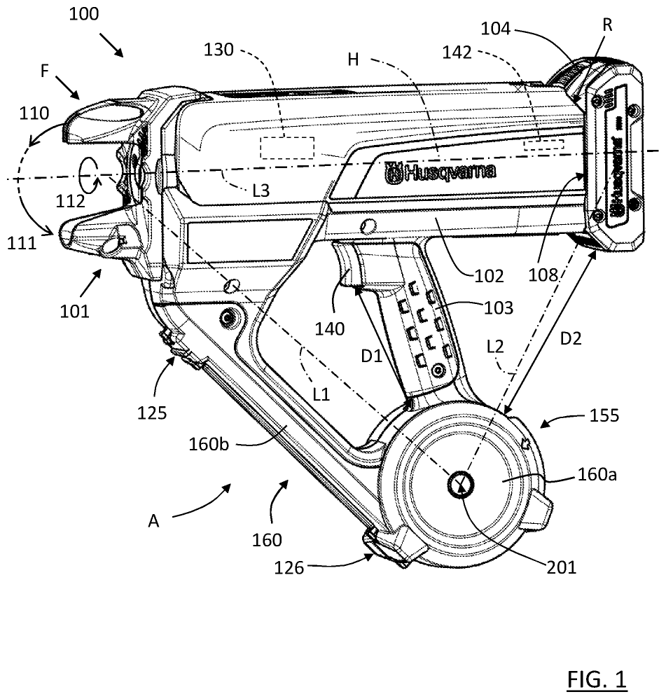

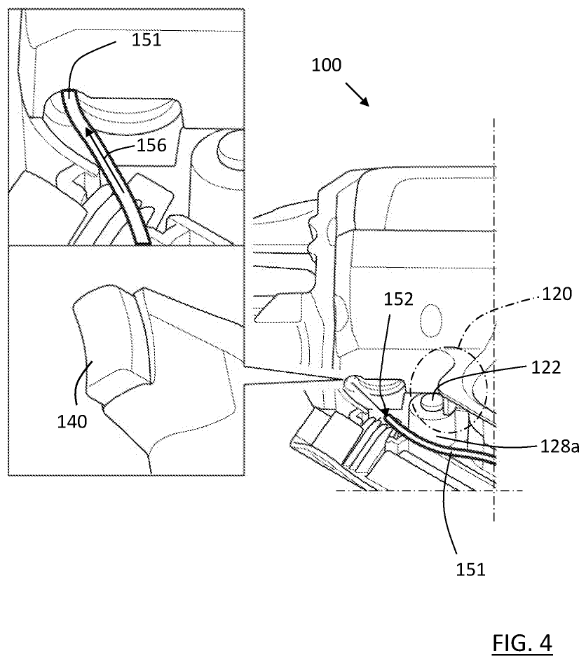

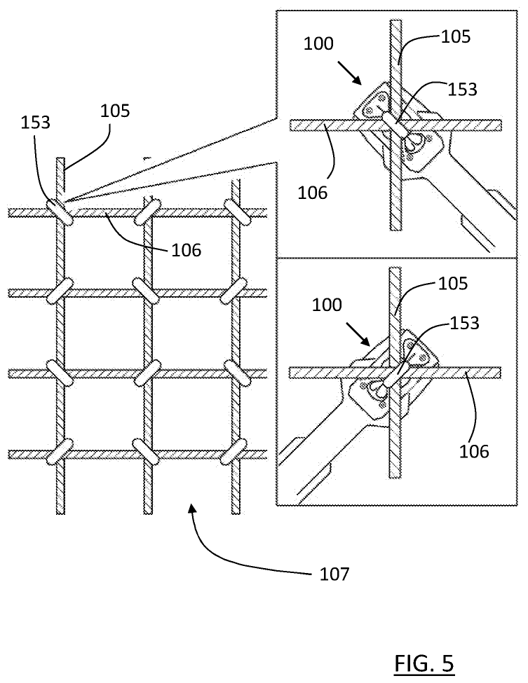

With reference to FIG. 1 and FIG. 5, there is a wire tying machine 100 adapted to tie wire knots 153 that secure reinforcement bars 105, 106, or rebars, together, such that a rebar structure 107 can be secured. With reference also to FIG. 4 that shows how wire is loaded and thread into the wire tying machine, when pressing a trigger 140 comprised in the wire tying machine 100, the wire tying machine 100 is arranged to feed 156, 110 a free end 152 of a wire 151 out from an opening in a tying head 101 of the wire tying device 100. The wire 151 is rolled prior to being fed out from the wire tying head 101, and therefore assumes an arcuate form due to the rolling inside the tying head 101. EP 2666932 discusses rolling wire such that it extends in an arcuate form when exiting a wire tying head. Rolling arrangements for rolling rebar tying wire will therefore not be discussed in more detail herein.

The wire 151 extends along an arcuate path to encircle the reinforcement bars 105, 106 which are to be tied together and is then received 111 back in the tying head 101, where it is held and brought to rotate 112 about a wire tying head axis H, which rotation forms a knot 153 on the wire 151. The wire 151 is for example held by a wire locking mechanism comprised in the wire tying head 101 in a previously known manner, where the wire locking mechanism is brought to rotate 112 about the wire tying head axis H for forming the knot 153.

The wire tying machine 100 is according to some aspects also arranged to cut the wire 151.

The whole knot tying process is automatically executed in sequence when the wire tying machine is triggered by an operator using the trigger 140. Thus, the wire tying machine 100 allows for conveniently and efficiently tying together rebar structures 107. The knot tying process has been described to comprise that the wire is held and brought to rotate 112 about a wire tying head axis H, which rotation forms a knot 153 on the wire 151, but the knot tying process can be performed in many other ways, and generally the wire tying machine 100 is arranged to perform a tying procedure such that a knot 153 is formed on the wire 151.

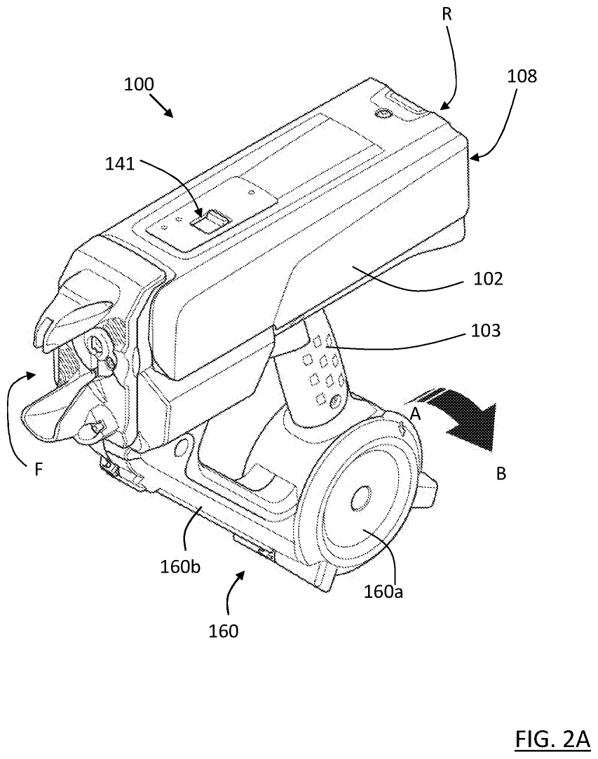

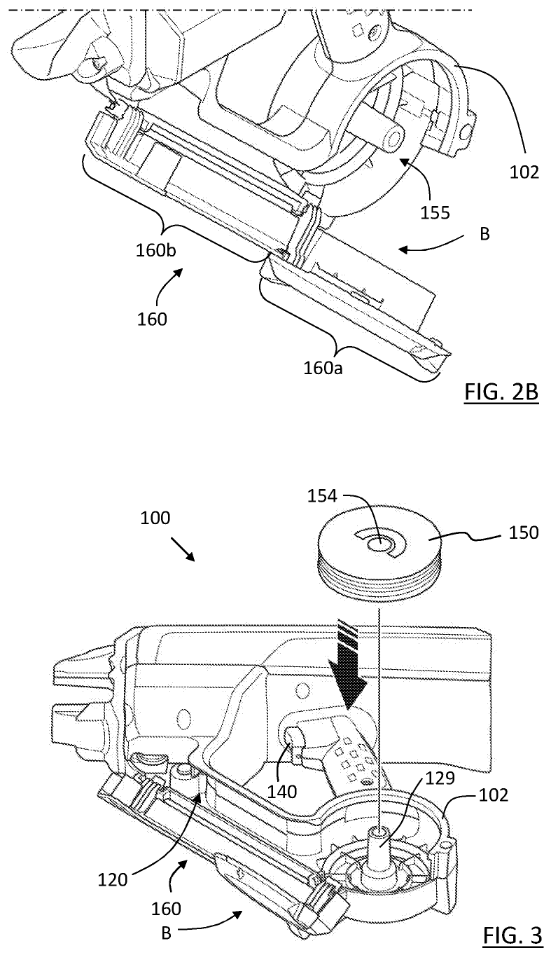

With reference also to FIG. 2A, FIG. 2B and FIG. 3, the wire tying machine 100 comprises a main body part 102 and a lid 160 that according to some aspects is connected to the main body part 102 by means of at least one hinge arrangement 125, 126. The main body part 102 comprises a handle 103, according to some aspects the trigger 140 is positioned on, or adjacent to, the handle 103.

The wire tying machine 100 further comprises a spool compartment 155 adapted to accommodate a wire spool 150 comprising a length of wire 151 behind the lid 160. According to some aspects the spool compartment 155 is positioned adjacent to the handle 103. The wire spool 150 is secured in the spool compartment 155 behind the lid 160 to make sure it is held in place and operates correctly during the tie processes, where the lid 160 serves as a protection for a user as well as for the wire tying machine 100. The wire spool 150 needs to be replaced when the wire 151 is depleted, and the lid 160 needs to be opened when replacing the wire spool 150. During the replacement procedure it is important to prevent that the wire tying machine 100 accidentally starts a tie operation, which may lead to injury of an operator, and/or to damage to the wire tying machine 100, and which at least may lead to a tangled wire 151.

According to the present disclosure, the wire tying machine 100 comprises a control unit arrangement 130 and a sensor arrangement 120, where the sensor arrangement 120 is adapted to detect if the lid 160 is in a closed position, as indicated by an “A”, or in an opened position, as indicated by a “B”, and to output a signal to the control unit arrangement 130, which signal is indicative of if the lid 160 is in the closed position A or in the opened position B. In FIG. 2A, it is indicated by an arrow how the lid 160 is brought from the closed position A to the opened position B.

This means that the control unit arrangement 130 is informed about the lid's position, and is enabled to set a certain appropriate operational state in dependence of the lid's position.

According to some aspects, in case the sensor arrangement 120 detects that the lid 160 has been set in the closed position A, this is communicated to the control unit arrangement 130 that is adapted to set the wire tying machine 100 in a normal running state. According to some further aspects, the normal running state includes that when the trigger 140 is pressed, the automatic knot tying process described above is executed. The normal running state is maintained as long as the sensor arrangement 120 detects that the lid 160 is in the closed position A.

This means that when the lid 160 is detected to be in the closed position A, the wire tying machine 100 is enabled to perform normal running procedures.

In case the sensor arrangement 120 detects that the lid 160 has been set in an opened position B, this is communicated to the control unit arrangement 130 which sets the wire tying machine 100 in a reload state, such that when the trigger 140 is pressed, the wire tying machine 100 is arranged to feed 156, 110 a free end 152 of the wire 151 towards and, according to some aspects, out from the opening in the tying head 101, without forming a knot 153 on the wire 151. This means that a complete tying process is not executed. The reload state is maintained as long as the sensor arrangement 120 detects that the lid 160 is in the opened position B.

This means that the function of the trigger 140 is different in dependence of if the lid 160 is in the opened position B or in the closed position A, the same trigger 140 having two different functional states depending on the detected position of the lid 160.

In particular this means that the function of the trigger is different in dependence of if the lid is in the opened position or in the closed position, the same trigger having two different functional states, depending on the detected position of the lid. Since no knot is tied when the sensor arrangement detects that the lid has been set in the opened position, the risk for tangling of the wire and also the risk for personal injuries during loading of a new wire spool is greatly reduced. Furthermore, since the wire tying machine is arranged to feed the free end of the wire towards the tying head when pressing in the reload state, the loading of the new wire is simplified.

According to some aspects, the lid 160 comprises a first lid part 160a and a second lid part 160b, where the first lid part 160a is adapted to cover the spool compartment 155 and the second lid part 160b is adapted to cover the wire 152 when fed from the wire spool 150 towards the opening in the tying head 101.

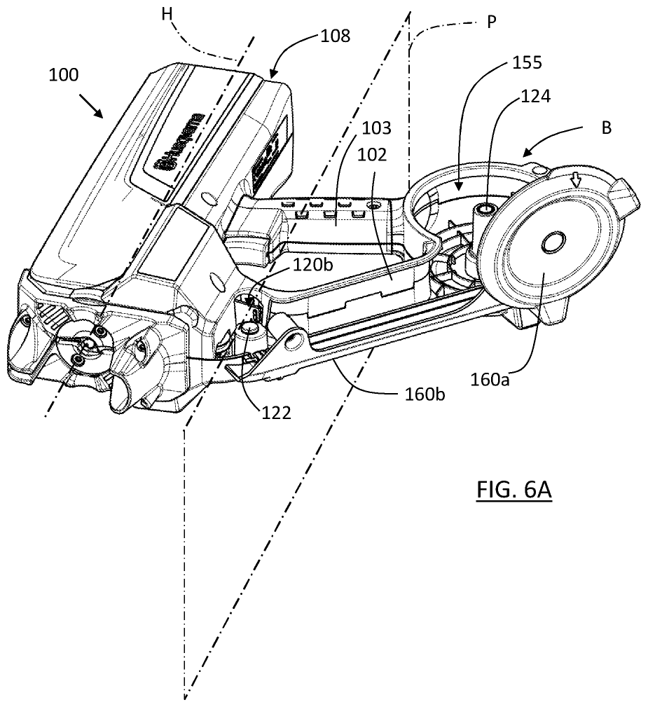

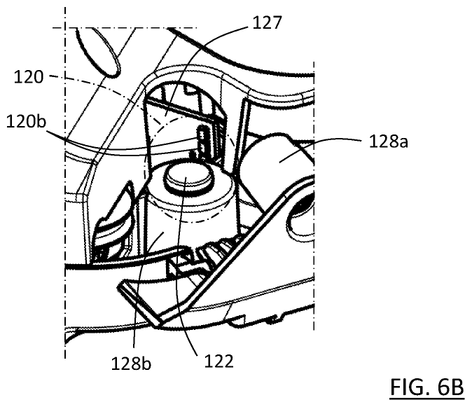

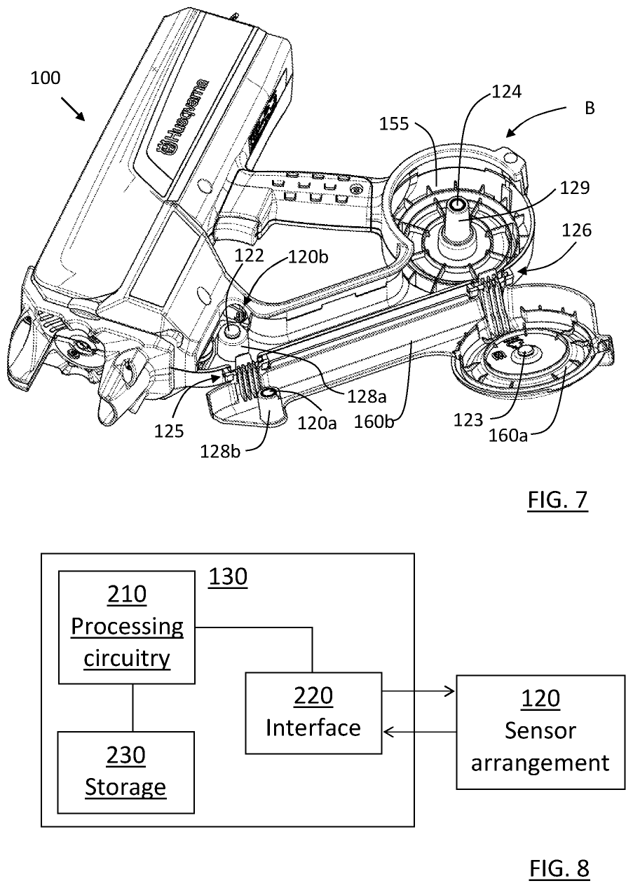

According to some aspects, with reference also to FIG. 6A, FIG. 6B and FIG. 7, the sensor arrangement 120 comprises a first magnet 120a, positioned on the lid 160, and a hall-sensor element arrangement 120b mounted in a fixed position on the main body part 102. FIG. 6A shows the lid 160 in a partly opened position, FIG. 6B shows an enlarged portion of FIG. 6A, and FIG. 7 shows the lid 160 in an even more opened position. For explanatory reasons, wall parts of the main body part 102 are here removed to at least partly expose the hall-sensor element arrangement 120b. This means that in the case of a wired connection to the hall-sensor element arrangement, no wires are needed to run to and from the lid.

The hall-sensor element arrangement 120b is adapted to measure a magnetic field generated by the first magnet 120a, and to output a signal to the control unit arrangement 130, which signal is indicative of if the lid 160 is in the closed position A or in the opened position B. The control unit arrangement 130 is adapted to set and maintain the function of the trigger 140 accordingly.

This means that standard components can be used, providing reliability and low cost.

The first magnet 120a and the hall-sensor element arrangement 120b may be mounted in reversed positions such that the hall-sensor element arrangement 120b is mounted to the lid 160 and the first magnet 120a is mounted to the main body part 102. Therefore, generally, the sensor arrangement 120 comprises a first magnet 120a and a hall-sensor element arrangement 120b which are adapted to be separated when the lid 160 is brought from the closed position A to the opened position B.

According to some aspects the hall-sensor element arrangement 120b comprises two or more hall sensor elements 120b mounted on a printed circuit board (PCB) 127. Having more than one hall sensor element 120b provides redundancy that results in a more reliable detection of if the lid 160 is in the closed position A or in the opened position B, for example if one hall sensor element 120b malfunctions.

According to some aspects, the sensor arrangement 120 is connected to the control unit arrangement 130 by means of one or more wires, or by means of a wireless connection. Optical connections are also conceivable.

According to some aspects, when the lid 160 is in the closed position A, the hall-sensor element arrangement 120b detects a magnetic field from the first magnet 120a, and an electric current is output to the control unit arrangement 130. When the lid 160 is in the opened position B, the hall-sensor element arrangement 120b ceases to detect a magnetic field from the first magnet 120a, and no electric current is output to the control unit arrangement 130. This provides extra security, since if the electric current signal is interrupted by accident, the wire tying machine 100 is set in the reload state irrespective of if the lid 160 is in the opened positioned B or in the closed position A. In this manner, the risk for tangled wires and personal injuries is reduced.

Generally, according to some aspects, the signal that is indicative of if the lid 160 is in the closed position A or in the opened position B is constituted by the presence or absence of an electric current. Many other alternatives are of course conceivable, the above example only being one of many possible examples.

By means of the present disclosure, a plurality of advantages are obtained. For example, the interface between the wire tying machine 100 and a user can be streamlined and kept to a minimum, only one trigger 140 is needed. This makes it easy for a new user to use the wire tying machine 100 with less learning required. Furthermore, the risk for a user to believe that the wire tying machine 100 is in the reload state, when the wire tying machine 100 actually is in the normal running state is kept to a minimum. Any accidental cavitation of the trigger 140 in the reload state will only lead to that the wire tying machine 140 feeds a free end 152 of the wire 151 towards and possibly out from the opening in the tying head 101, heavily reducing the risk of injury during wire spool change operation.

According to some aspects, the wire tying machine 100 comprises an optional on-off switch 141 that enables the trigger 140 to be operational in the “on” setting, and in the “off” setting the trigger 140 is disengaged and thus not operational.

According to some aspects, the wire tying machine 100 comprises a first metal pad 122 that is adapted to attract the first magnet 120a such that the lid 160 is adapted to be retained in the closed position A by means of magnetic attraction force between the first magnet 120a and the first metal pad 122. The first metal pad 122 can for example be mounted on a first pin 128a that is formed in the main body part 102, and the first magnet 120a can for example be mounted on a second pin 128b that is formed in the lid 160.

This means that the same magnet 120a can be used in the sensor arrangement 120 and for retaining the lid 160 in the closed position A.

In this example, the first metal pad 122 is mounted in a fixed position on the main body part 102. As mentioned above, the first magnet 120a and the hall-sensor element arrangement 120b may be mounted in reversed positions, and then the first metal pad 122 is mounted to the lid 160.

According to some aspects, the wire tying machine 100 comprises a second metal pad 123 that is mounted to the lid 160 and a second magnet 124 that is mounted in a fixed position on the main body part 102 and is adapted to attract the second magnet 124 such that the lid 160 is adapted to be retained in the closed position A by means of magnetic attraction force between the second magnet 124 and the second metal pad 123. In this way, the lid 160 can be retained in the closed position A in an even more reliable manner. For example, the second magnet 124 can be mounted to a centre pin 129 that is adapted to engage a centre aperture 154 of the wire spool 150 as shown in FIG. 3.

The second metal pad 123 and the second magnet 124 may be mounted in reversed positions such that the second magnet 124 is mounted to the lid 160 and the second metal pad 123 is mounted to the main body part 102.

According to some aspects, the second magnet 124 and a further hall-sensor element arrangement can be comprised in the sensor arrangement such that an even more reliable detection of if the lid 160 is in the closed position A or in the opened position B can be provided.

According to some aspects, the sensor arrangement may instead comprise one or more electrical switches, possibly in combination with one or more magnets and hall-sensor element arrangements. This means that many different types of components and even combinations of different types of components are conceivable for the sensor arrangement. Such an electrical switch my for example be connected to a current source and be arranged to be closed when the lid 160 is in the closed position A, such that an electric current is output to the control unit arrangement 130. When the lid 160 is in the opened position B, the switch is opened, and no electric current is output to the control unit arrangement 130. In this case, the signal that is indicative of if the lid 160 is in the closed position A or in the opened position B is constituted by the presence or absence of an electric current. Of course the switch can be open when the lid 160 is in the closed position A and closed when the lid 160 is in the opened position B. The switch may further be of an optical type such that the signal that is indicative of if the lid 160 is in the closed position A or in the opened position B is constituted by the presence or absence of the optical signal.

According to some aspects, generally, when the lid 160 is in the closed position A, an electric current or other signal, such as an optical signal, is output to the control unit arrangement 130, and when the lid 160 is in the opened position B, no electric current or other signal is output to the control unit arrangement 130. Alternatively, when the lid 160 is in the opened position B, an electric current or other signal, such as an optical signal, is output to the control unit arrangement 130, and when the lid 160 is in the closed position A, no electric current or other signal is output to the control unit arrangement 130.

According to some aspects, the sensor arrangement may instead comprise one or more digital switches, such that the signal that is indicative of if the lid 160 is in the closed position A or in the opened position B is constituted by different digital words that are communicated to the control unit arrangement 130.

It is apparent that many different options are available for communicating the signal that is indicative of if the lid 160 is in the closed position A or in the opened position B.

The lid 160 can be retained in the closed position A by means of other locking means that the magnetic means described above, for example by means of snap-lock members or screws.

FIG. 8 schematically illustrates, in terms of a number of functional units, the components of the control unit arrangement 130 according to an embodiment of the discussions herein. Processing circuitry 210 is provided using any combination of one or more of a suitable central processing unit CPU, multiprocessor, microcontroller, digital signal processor DSP, etc., capable of executing software instructions stored in a computer program product, e.g. in the form of a storage medium 230. The processing circuitry 210 may further be provided as at least one application specific integrated circuit ASIC, or field programmable gate array FPGA.

Particularly, the processing circuitry 210 is configured to cause the control unit 130 to perform a set of operations, or steps. For example, the storage medium 230 may store the set of operations, and the processing circuitry 210 may be configured to retrieve the set of operations from the storage medium 230 to cause the control unit 130 to perform the set of operations. The set of operations may be provided as a set of executable instructions. Thus, the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The control unit 130 may further comprise an interface 220 for communications with at least one external device, such as the sensor arrangement 120. As such, the interface 220 may comprise one or more transmitters and receivers, comprising analogue and digital components and a suitable number ports for wireline or wireless communication.

The processing circuitry 210 controls the general operation of the control unit 130 e.g. by sending data and control signals to the interface 220 and the storage medium 230, by receiving data and reports from the interface 220, and by retrieving data and instructions from the storage medium 230. Other components, as well as the related functionality, of the control node are omitted in order not to obscure the concepts presented herein.

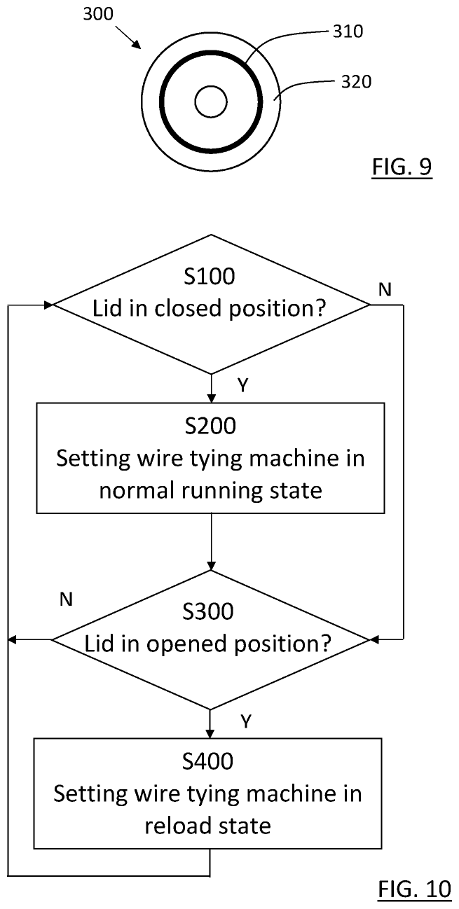

FIG. 9 shows a computer program product 300 comprising computer executable instructions 310 on computer media 320 to execute any of the methods disclosed herein.

The present disclosure also relates to a computer program 310 for controlling loading and threading reinforcement bar tying wire into a wire tying machine 100 that comprises a lid 160, a trigger 140, a sensor arrangement 120 and a tying head 101, where the lid 160 is adapted to at least partly cover spool compartment 155 adapted to accommodate a wire spool 150. The computer program 310 comprises computer code which, when run on processing circuitry 210 of a control unit arrangement 130, causes the control unit arrangement 130 to control the function of the trigger 140 in dependence of a signal received from the sensor arrangement 120.

The function of the trigger 140 is controlled such that when the received signal is indicative of that the lid 160 is in a closed position A, the wire tying machine 100 is set in a normal running state such that when the trigger 140 is pressed, the wire tying machine 100 is arranged to feed 156, 110 a free end 152 of wire 151 on the wire spool 150 out from the opening in the tying head 101 such that the wire 151 extends along an arcuate path to encircle reinforcement bars 105, 106 which are to be tied together and is then received 111 back in the tying head 101, where the wire tying machine 100 is arranged to perform a tying procedure such that a knot 153 is formed on the wire 151.

The function of the trigger 140 is also controlled such that when the received signal is indicative of that the lid 160 is in an opened position B, the wire tying machine 100 is set in a reload state such that when the trigger 140 is pressed, the wire tying machine 100 is arranged to feed 156, 110 the free end 152 of the wire 151 towards the tying head 101, but without forming a knot 153 on the wire 151.

The present disclosure also relates to a control unit arrangement 130 adapted to control a function of a trigger 140 comprised in a wire tying machine 100 that also comprises a lid 160, a trigger 140, a sensor arrangement 120 and a tying head 101. The lid 160 is adapted to at least partly cover spool compartment 155 adapted to accommodate a wire spool 150, where the control unit arrangement 130 is adapted to control the function of the trigger 140 in dependence of a signal received from the sensor arrangement 120.

The function of the trigger 140 is controlled such that when the received signal is indicative of that the lid 160 is in a closed position A, the wire tying machine 100 is set in a normal running state such that when the trigger 140 is pressed, the wire tying machine 100 is arranged to feed 156, 110 a free end 152 of wire 151 on the wire spool 150 out from the opening in the tying head 101 such that the wire 151 extends along an arcuate path to encircle reinforcement bars 105, 106 which are to be tied together and is then received 111 back in the tying head 101, where the wire tying machine 100 is arranged to perform a tying procedure such that a knot 153 is formed on the wire 151.

The function of the trigger 140 is also controlled such that when the received signal is indicative of that the lid 160 is in an opened position B, the wire tying machine 100 is set in a reload state such that when the trigger 140 is pressed, the wire tying machine 100 is arranged to feed 156, 110 the free end 152 of the wire 151 towards the tying head 101, but without forming a knot 153 on the wire 151.

With reference to FIG. 10, the present disclosure also relates to a method for controlling loading and threading of reinforcement bar tying wire into a wire tying machine 100 that comprises a lid 160, a trigger 140, a sensor arrangement 120 and a tying head 101. The lid 160 is adapted to at least partly cover spool compartment 155 adapted to accommodate a wire spool 150.

The method comprises determining S100 if the received signal is indicative of that the lid 160 is in a closed position A, and if that is the case setting S200 the wire tying machine 100 in a normal running state such that when the trigger 140 is pressed, the wire tying machine 100 is arranged to feed 156, 110 a free end 152 of wire 151 on the wire spool 150 out from the opening in the tying head 101 such that the wire 151 extends along an arcuate path to encircle reinforcement bars 105, 106 which are to be tied together and is then received 111 back in the tying head 101, where the wire tying machine 100 is arranged to perform a tying procedure such that a knot 153 is formed on the wire 151.

The method further comprises determining S300 if the received signal is indicative of that the lid 160 is in an opened position B, and if that is the case, setting S400 the wire tying machine 100 in a reload state such that when the trigger 140 is pressed, the wire tying machine 100 is arranged to feed 156, 110 the free end 152 of the wire 151 towards the tying head 101, but without forming a knot 153 on the wire 151.

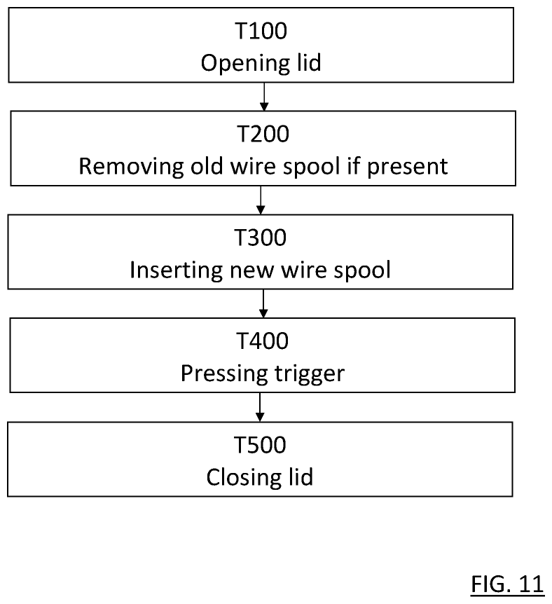

With reference to FIG. 11, the present disclosure also relates to a method, for loading and threading reinforcement bar tying wire into a wire tying machine 100 that comprises a lid 160, a trigger 140 and a tying head 101. The method comprising opening T100 the lid 160 to an opened position B such that access is provided to a spool compartment 155 adapted to accommodate a wire spool 150, and if an old wire spool is present, removing T200 the old wire spool, inserting T300 a new wire spool 150 that comprises a length of wire 151. The method further comprises pressing T400 the trigger 140 which prompts the wire tying machine 100 to feed 156, 110 a free end 152 of the wire 151 towards an opening in the tying head 101, without forming a knot 153 on the wire 151, while the lid 160 is in the opened position B, and closing T500 the lid 160 to a closed position A.

The present disclosure is not limited to the above examples, but may vary freely within the scope of the appended claims. For example, the metal pads 122, 123 may be made in a ferromagnetic material.

According to some aspects, each time the trigger 140 is pressed in the reload state, the wire tying machine 100 is arranged to feed 156, 110 the free end 152 of the wire 151 a certain predetermined distance, and/or during a certain predetermined time and then stopping.

According to some aspects, in case the sensor arrangement 120 detects that the lid 160 has been set in the opened position B, this is communicated to the control unit arrangement 130 that is adapted to set the wire tying machine 100 in a reload state, such that the trigger 140 is de-activated. This means that in the reload state, the trigger is disconnected from any functionality.

According to some aspects, as schematically indicated with dashed lines in FIG. 1, the wire tying machine 100 comprises a separate reload trigger 142, where, when the reload trigger 142 is pressed, the wire tying machine 100 is arranged to feed 156, 110 the free end 152 of the wire 151 towards the tying head 101, but without forming a knot 153 on the wire 151. In this way, the reload trigger 142 can be used when the trigger 140 is de-activated. The indicated position of the reload trigger 142 is only an example, the reload trigger 142 can have any suitable position on the wire tying machine 100.

According to some aspects, the main body part 102 is constituted by the complete body of the wire tying machine 100 except the lid 160.

According to some aspects, as schematically indicated in FIG. 1, the wire tying machine 100 comprises a rechargeable battery 104 (only shown mounted in FIG. 1) that is used as an energy source, where the wire tying machine 100 comprises a battery receptacle 108 in the main body part 102 for receiving the battery 104. Other types of energy sources are of course conceivable, such as for example a main electric source.

With reference to FIG. 1, the present disclosure also relates to a wire tying machine 100 adapted to tie wire knots 153 that secure reinforcement bars 105, 106 together, where the wire tying machine 100 comprises a main body part 102, a trigger 140 for activating a knot tying procedure, a wire tying head 101 at a front end F of the wire tying machine 100, a battery receptacle 108 in the main body part 102 for receiving a battery 104, and a spool compartment 155 that is adapted to accommodate a wire spool 150 comprising a length of wire 151. The wire tying machine 100 is arranged to feed 110 a free end 152 of the wire 151 out from an opening in the wire tying head 101 and to receive the free end 152 into another opening of the wire tying head 101, where the wire tying machine 100 is arranged to perform a tying procedure such that a knot 153 is formed on the wire 151. The battery receptacle 108 is arranged at a rear end R of the wire tying machine 100, opposite to the front end F.

The wire 151 is held in the tying head 101 and brought to rotate 112 about a wire tying head axis H such that a knot 153 is formed on the wire 151. The trigger 140 is arranged between the wire tying head axis H and the spool compartment 155, and the wire tying head axis H intersects with the battery 104 when the battery 104 is inserted into the battery receptacle 108. This means that the battery receptacle 108 and the tying head 101 are positioned on opposite sides of the wire tying head axis H, the battery receptacle 108 being the part of the wire tying machine 100 that is positioned farthest from the tying head 101 along the wire tying head axis H. When a battery 140 is mounted, the battery is positioned even farther from the tying head 101 along the wire tying head axis H.

According to some aspects, the battery 140 is exchangeable, the battery receptacle 108 being adapted for easy connection/disconnection of a battery 140 such that one battery 140 can be replaced with another battery when depleted. The depleted battery can then be recharged and the wire tying machine 100 can be used during recharging.

According to some aspects, with reference also to FIG. 6A, a plane P that runs parallel to the wire tying head axis H also runs between, on one hand, the tying head 101 and the battery receptacle 108, and, on the other hand, the spool compartment 155.

According to some aspects, the trigger 140 is positioned between the wire tying head axis H and the spool compartment 155.

According to some aspects, a shortest distance D1 between the spool compartment 155 and the trigger 140 falls below a shortest distance D2 between the spool compartment 155 and the battery 104 when the battery 104 is inserted into the battery receptacle 108.

According to some aspects, as shown in FIG. 1, the trigger 140 is positioned within a triangle L1, L2, L3 that is formed by
a first line L1 that runs between an intersection between the wire tying head axis H and the wire tying head 101, and a center 201 of the spool compartment 155,
a second line L2 that runs between the center 201 of the spool compartment 155, and an intersection between the wire tying head axis H and a mounted battery 104, and
a third line L3 that runs between the two other lines L1, L2 along the wire tying head axis H. The third line L3 thus partly coincides with the wire tying head axis H.

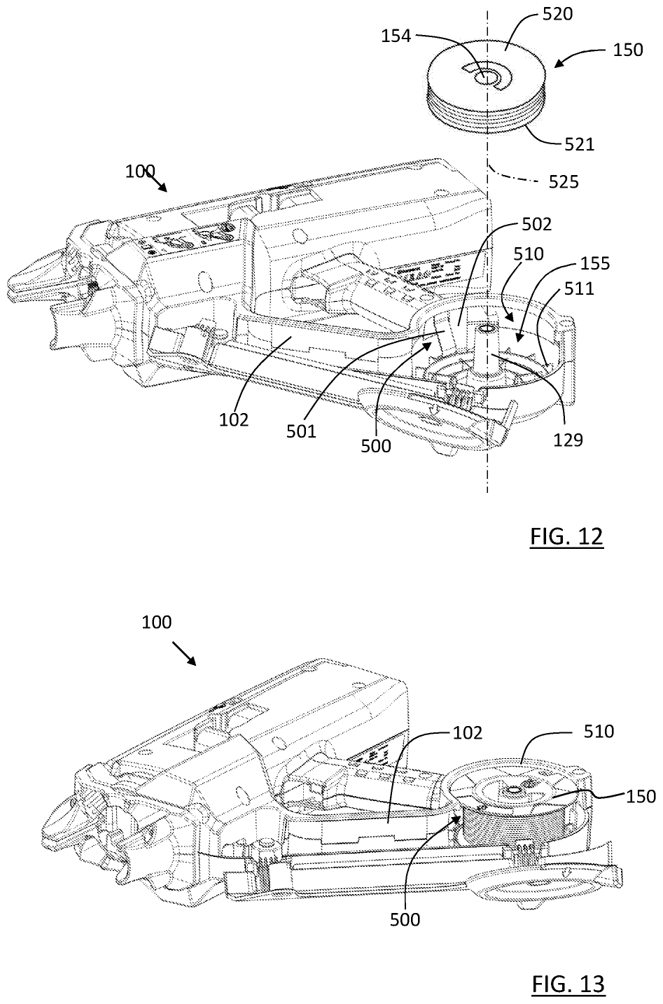

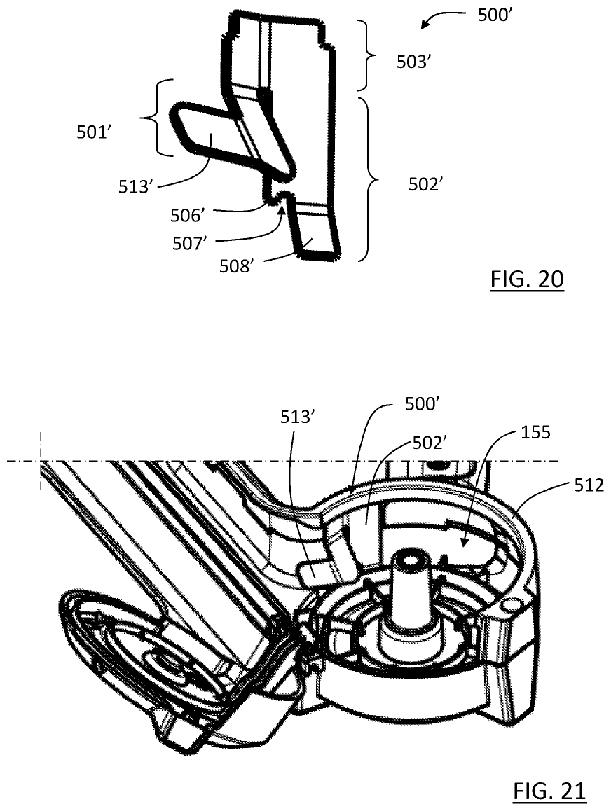

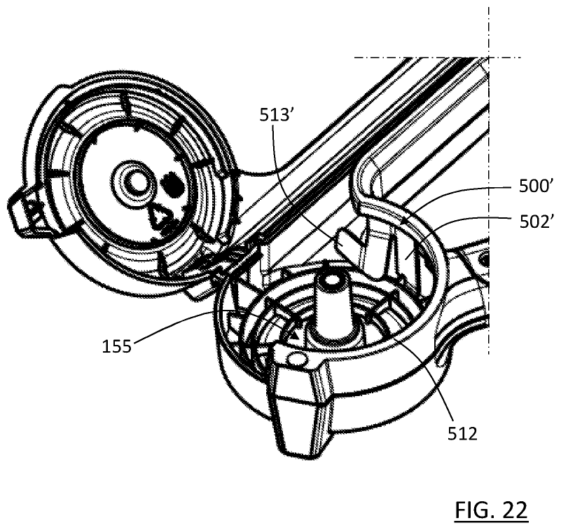

According to some aspects, with reference to FIG. 12-FIG. 22, the wire tying machine 100 according to any one of the examples described herein further comprises a retaining clip 500, 500′. A first example of the retaining clip 500 will first be described with reference to FIG. 12-FIG. 19, and a second example of the retaining clip 500′ will then be described with reference to FIG. 20-FIG. 22.

It should be understood that most features that are described for the first example of the retaining clip 500 are applicable for the second example of the retaining clip 500′, only minor details separating the two examples of the retaining clip 500, 500′ as will be understood from the following.

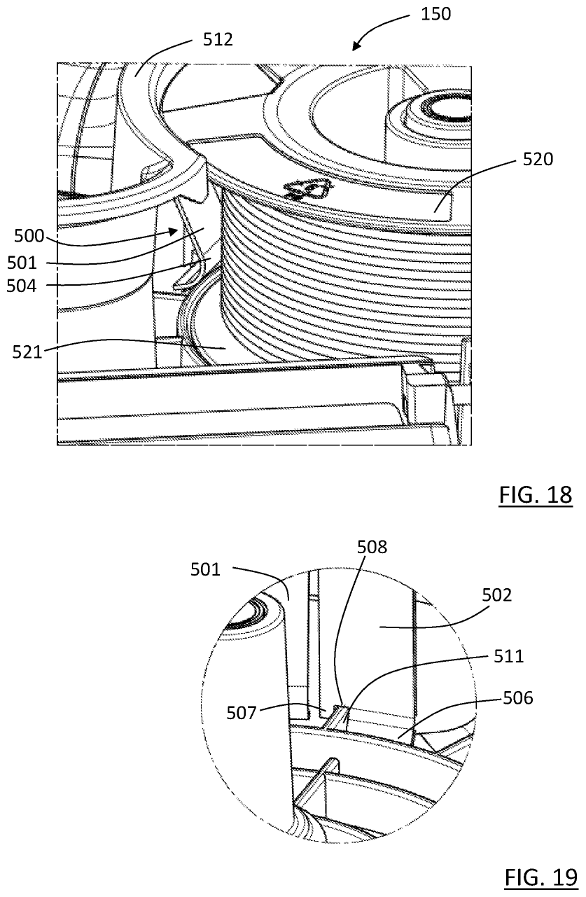

The retaining clip 500 comprises a resilient member 501, an attachment member 502 and a common member 503, and is attached to the main body part 102 such that the resilient member 501 protrudes into the spool compartment 155. The resilient member 501 is adapted to be positioned between rim parts 520, 521 of an inserted wire spool 150 such that an inserted wire spool 150 is retained in the spool compartment 155, as in particular illustrated in FIG. 18. The rim parts 520, 521 provide ends for a cylinder onto which a wire is rolled. Normally, the rim parts 520, 521 are the parts of the wire spool 150 that have the largest diameter, and constitute outer limits for the roll od wire.

This means that should the lid 160 accidentally open, the inserted wire spool 150 is prevented from falling out by the resilient member 501 engaging a rim part 521 that is closest to a bottom 514 of the spool compartment 155.

According to some aspects, the retaining clip 500 is attached to a spool compartment wall part 510 that is comprised in the main body part 102, such that the retaining clip 500 faces a mounted wire spool 150, as for example shown in FIG. 17 and FIG. 18.

This means that the retaining clip 500 is mounted on the side of the spool compartment wall part 510 that faces the mounted wire spool 150, and is thus easily accessible.

According to some aspects, the common member 503 is at least partly retained by a body rim 512 that runs along and covers a periphery of the spool compartment wall part 510, as for example shown in FIG. 17 and FIG. 18. This means that the retaining clip 500 is retained at the common member 503 that faces away from the bottom 514 of the spool compartment 155.

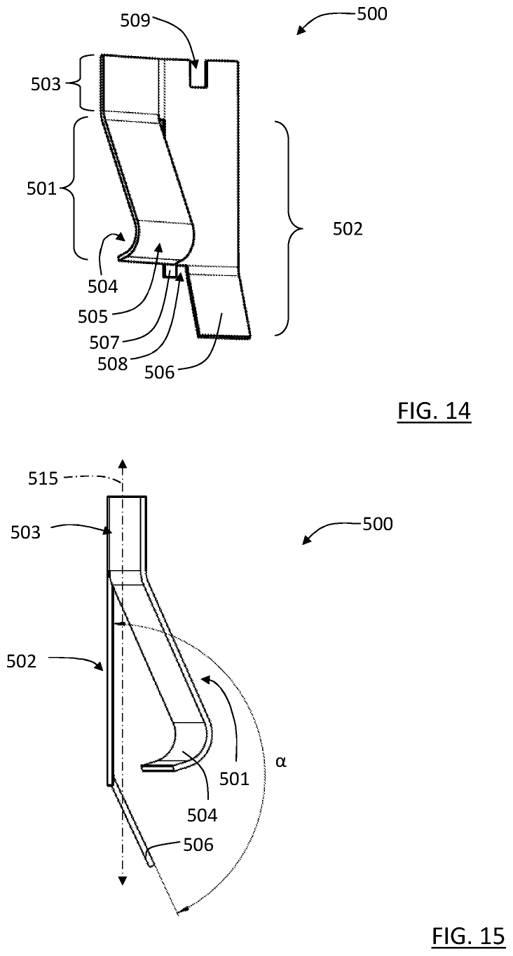

According to some aspects, the resilient member 501 and the attachment member 502 extend mainly parallel from the common member 503, as for example shown in FIG. 14. According to some further aspects, the resilient member 501 and the attachment member 502 extend mainly along a longitudinal extension 515 that follows the spool compartment wall part 510. This means that the retaining clip 500 does not unnecessarily protrude into the spool compartment 155. As mentioned previously, however, the resilient member 501 protrudes into the spool compartment 155 such that the resilient member 501 can perform its retaining function.

According to some aspects, at least one of the attachment member 502 and the common member 503 comprises a slot 508, 509 that is adapted to receive a corresponding ridge 511 formed in the spool compartment 155. As shown in FIG. 17 and FIG. 19, the corresponding ridge 511 is formed in the bottom 514 of the spool compartment 155. FIG. 12 and FIG. 17 illustrate any ridge, and the more detailed FIG. 18 illustrates the ridge received in one slot that is formed the bottom 514 of the spool compartment 155. Another slot 509 may be received in a ridge formed closer to the periphery of the spool compartment wall part 510 that is covered by the body rim 512.

As follows from the above, the retaining clip 500 is securely attached to the spool compartment 155, according to some aspects due to its shape in relation to the spool compartment wall part 510 and requires no additional fixing means such as screws, adhesive or the like. According to some aspects, the retaining clip 500 is formed as one integral part, according to some further aspects formed in flexible sheet metal or the like. This means that only one item needs to be manufactured and mounted to achieve the retaining function of the retaining clip 500.

According to some aspects, at least one slot 508 is formed in the attachment member 502, between a protrusion 508 and a holding member 506, where the protrusion 508 and the holding member 506 are comprised in the attachment member 502. This provides further stability such that the retaining clip 500 is prevented from moving across its longitudinal extension 515.

According to some aspects, the holding member 506 extends at a first angle α to the rest of the attachment member 502, towards a mounted wire spool 150, where the first angle α lies in the interval 140°-170°. More preferably, the first angle α lies in the interval 150°-160°. This means that the holding member 506 follows a shape of the bottom 514 of the spool compartment 155 as hinted in FIG. 19.

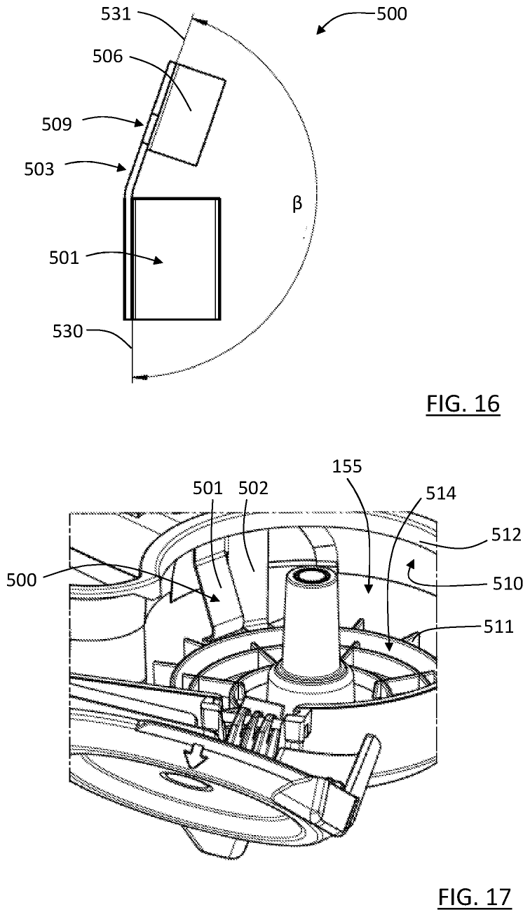

According to some aspects, the common member 503 is bent such that the resilient member 501 runs along a first plane 530 and the attachment member 502 runs along a second plane 531, and such that the resilient member 501 and the attachment member 502 are brought closer together as illustrated in FIG. 16. There is a second angle β between the first plane 530 and the second plane 531, where the second angle β lies in the interval 145°-175°. More preferably, the second angle β lies in the interval 155°-165°. This means that the retaining clip 500 follows a shape of the spool compartment wall part 510.

According to some aspects, as specific for the first example of a retaining clip 500 according to the above, the resilient member 501 comprises an arcuate part 504 with an outer periphery 505 that is adapted to face a mounted wire spool 150. The arcuate part 504 protrudes into the spool compartment 155 such that the resilient member 504 is adapted to be positioned between the rim parts 520, 521 of an inserted wire spool 150 such that an inserted wire spool 150 is retained in the spool compartment 155.

This means that by adjusting the shape of the arcuate part 504 in view of the resilient characteristics of the resilient member 501, a user may insert a new wire spool 150 by pressing it into the spool compartment 155 such that the rim part 521 that is going to be closest to the bottom 514 of the spool compartment 155 engages the arcuate part 504 and presses the arcuate part 504 against the spool compartment wall part 510. When the rim part 521 has cleared the arcuate part 504, the arcuate part 504 springs back such that it is positioned between the rim parts 520, 521 and prevents the wire spool 150 from accidentally falling out of the spool compartment 155.

When a wire spool 150 is about to be removed from the spool compartment 155, a user pulls the wire spool 150 out from the spool compartment such that the the rim part 521 that is has been closest to the bottom 514 of the spool compartment 155 engages the arcuate part 504 and presses the arcuate part 504 against the spool compartment wall part 510. When the rim part 521 has cleared the arcuate part 504, the arcuate part 504 springs back and the wire spool 150 is free from the retaining clip 500.

This means that the wire spool 150 can be inserted into, or removed from, the spool compartment 155, by only moving the wire spool 150 with sufficient force.

According to some aspects, as specific for the second example of a retaining clip 500′ according to the above, the resilient member 501′ comprises a handle part 513′. The handle part 513′ extends away from the rest of the resilient member 501′ such that a user is enabled to insert a wire spool 150, or release an inserted wire spool 150, by depressing the handle part 513′ such that the resilient member 501 clears the rim parts 520, 521.

According to some aspects, the handle part 513′ mainly extends away from the rest of the resilient member 501′ perpendicular to the longitudinal extension 515.

This means that a user may insert a new wire spool 150 by pressing the handle part 513′ towards the spool compartment wall part 510 and lower the spool without the resilient member 501′ engaging the rim part 521 that is going to be closest to the bottom 514 of the spool compartment 155. When the rim part 521 has cleared the resilient member 501′, the user can release the handle part 513′ such that the resilient member 501′ springs back such that it is positioned between the rim parts 520, 521 and prevents the wire spool 150 from accidentally falling out of the spool compartment 155.

When a wire spool 150 is about to be removed from the spool compartment 155, a user can press the handle part 513′ towards the spool compartment wall part 510 and pulls the wire spool 150 out from the spool compartment such that the the rim part 521 that is has been closest to the bottom 514 of the spool compartment 155 does not engage the rim part 521 that is has been closest to the bottom 514 of the spool compartment 155. When the rim part 521 has cleared the resilient member 501′, the user can release the handle part 513′ such that the resilient member 501′ springs back and the wire spool 150 is free from the retaining clip 500′.

This means that the resilient member 501′ can be easily moved out of the way when a wire spool 150 is to be inserted into, or removed from, the spool compartment 155. This also means that the resilient member 501′ can have any suitable shape to provide desired retaining characteristics. As shown in FIG. 20-FIG. 22, the resilient member 501′ has a flat shape without any arcuate parts, which provides a secure retaining functionality. It is, however, possible that the resilient member comprises an arcuate part as described for the first example, or has any other suitable shape.

According to some aspects, the retaining clip 500, 500′ admits that the wire spool 150 rotates around a centre pin 129 that is adapted to engage a centre aperture 154 of the wire spool 150 as shown in FIG. 12, but prevents that the wire spool 150 moves along an insertion/removal axis 129 that runs along a longitudinal extension of the centre pin 129.

The present disclosure also relates to a retaining clip 500 adapted to retain a wire spool 150 that is inserted in a spool compartment 155 of a wire tying machine 100, where the retaining clip 500 comprises a resilient member 501, an attachment member 502 and a common member 503. The retaining clip 500 is adapted to be attached to a main body part 102 of a wire tying machine 100, such that the resilient member 501 can protrude into the spool compartment 155 and be positioned between rim parts 520, 521 of an inserted wire spool 150 such that an inserted wire spool 150 is retained in the spool compartment 155.

According to some aspects, the retaining clip 500 is adapted to be attached to a spool compartment wall part 510 that is comprised in a main body part 102 of a wire tying machine 100, such that the retaining clip 500 is adapted to face a mounted wire spool 150.

According to some aspects, the common member 503 is adapted to be at least partly retained by a body rim 512 that runs along and covers a periphery of the spool compartment wall part 510.

According to some aspects, the resilient member 501 and the attachment member 502 extend mainly parallel from the common member 503.

According to some aspects, at least one of the attachment member 502 and the common member 503 comprises a slot 508, 509 that is adapted to receive a corresponding ridge 511 formed in the spool compartment 155.

According to some aspects, at least one slot 508 is formed in the attachment member 502, between a protrusion 508 and a holding member 506, where the protrusion 508 and the holding member 506 are comprised in the attachment member 502.

According to some aspects, the holding member 506 extends at a first angle α to the rest of the attachment member 502, towards a mounted wire spool 150, where the first angle α lies in the interval 140°-170°.

According to some aspects, the common member 503 is bent such that the resilient member 501 runs along a first plane 530 and the attachment member 502 runs along a second plane 531, and such that the resilient member 501 and the attachment member 502 are brought closer together, where there is a second angle β between the first plane 530 and the second plane 531, where the second angle β lies in the interval 145°-175°.

According to some aspects, the resilient member 501 comprises an arcuate part 504 with an outer periphery 505 that is adapted to face a mounted wire spool 150, where the arcuate part 504 is adapted to protrude into a spool compartment 155 such that the resilient member 504 is adapted to be positioned between rim parts 520, 521 of an inserted wire spool 150 such that an inserted wire spool 150 is retained in the spool compartment 155.

According to some aspects, the resilient member 501′ comprises a handle part 513′ that extends away from the rest of the resilient member 501′ such that a user is enabled to insert a wire spool 150, or release an inserted wire spool 150, by depressing the handle part 513′ such that the resilient member 501′ can clear the rim parts 520, 521.

According to some aspects, the retaining clip 500, 500′ according to the above corresponds to the retaining clip 500, 500′ described previously as being comprised in a wire tying machine 100, being associated with the same features and advantages.

The present disclosure also relates to a method for using a wire tying machine 100 according to any one of the examples described herein. The method comprises controlling the wire tying machine 100 to feed 156, 110 a free end 152 of wire 151 on the wire spool 150 out from the opening in the tying head 101 such that the wire 151 extends along an arcuate path to encircle reinforcement bars 105, 106 which are to be tied together and is then received 111 back in the tying head 101, and further controlling the wire tying machine 100 to perform a tying procedure such that a knot 153 is formed on the wire 151.

According to some aspects, the method comprises bringing the tying head 101 to rotate 112 about a wire tying head axis H when the wire 151 is held in the tying head 101 such that a knot 153 is formed on the wire 151.

1. A wire tying machine adapted to tie wire knots that secure reinforcement bars together, where the wire tying machine comprises a lid, a main body par, a trigger and a spool compartment that is adapted to accommodate a wire spool comprising a length of wire behind the lid, wherein the wire tying machine is arranged to feed a free end of the wire out from an opening in a tying head of the wire tying machine, wherein the wire tying machine comprises a control unit arrangement and a sensor arrangement, wherein the sensor arrangement is adapted to detect if the lid is in a closed position or in an opened position, and to output a signal to the control unit arrangement, the signal indicating whether the lid is in the closed position or in the opened position.

2. The wire tying machine according to claim 1, wherein, in response to the sensor arrangement detecting that the lid has been set in the closed position, a communication is sent the control unit arrangement that is adapted to set the wire tying machine in a normal running state.

3. The wire tying machine according to claim 2, wherein, when the trigger is pressed in the normal running state, the wire tying machine is arranged to feed a the free end of the wire out from the opening in the tying head such that the wire extends along an arcuate path to encircle reinforcement bars which are to be tied together, wherein the wire tying machine is arranged to perform a tying procedure such that a knot is formed on the wire 1.

4. The wire tying machine according to claim 1, wherein, in response to the sensor arrangement detecting that the lid has been set in the opened position, a communication is sent to the control unit arrangement that is adapted to set the wire tying machine in a reload state, such that when the trigger is pressed, the wire tying machine is arranged to feed the free end of the wire towards the tying head, but without forming a knot on the wire.

5. The wire tying machine according to claim 1, wherein, in response to the sensor arrangement detecting that the lid has been set in the opened position, a communication is sent to the control unit arrangement that is adapted to set the wire tying machine in a reload state, such that the trigger is de-activated.

6. The wire tying machine according to claim 5, further comprising a separate reload trigger, wherein, when the reload trigger is pressed, the wire tying machine is arranged to feed the free end of the wire towards the tying head, but without forming a knot on the wire.

7. The wire tying machine according to claim 1, wherein the sensor arrangement comprises a first magnet and a hall-sensor element arrangement which are adapted to be separated when the lid is brought from the closed position to the opened position, wherein the hall-sensor element arrangement is adapted to measure a magnetic field generated by the magnet, and to output the signal to the control unit arrangement.

8. The wire tying machine according to claim 7, wherein the first magnet is positioned on the lid, and the hall-sensor element arrangement is mounted in a fixed position on the main body part.

9. The wire tying machine according to claim 8, wherein the wire tying machine comprises a first metal pad that is adapted to attract the first magnet such that the lid is adapted to be retained in the closed position by means of magnetic attraction force between the first magnet and the first metal pad.

10. The wire tying machine according to claim 1, wherein the sensor arrangement comprises one or more electrical switches.

11. The wire tying machine according to claim 1, wherein the signal is constituted by the presence or absence of an electric current.

12. The wire tying machine according to claim 11, wherein, when the lid is in the closed position, an electric current is output to the control unit arrangement, and when the lid is in the opened position, no electric current is output to the control unit arrangement.

13. The wire tying machine according to claim 1, wherein the signal is constituted by an optical signal or by digital words.

14. The wire tying machine according to claim 1, further comprising a retaining clip hat comprises a resilient member, an attachment member and a common member, wherein the retaining clip is attached to the main body part such that the resilient member protrudes into the spool compartment and is adapted to be positioned between rim parts of an inserted wire spool such that an inserted wire spool is retained in the spool compartment.

15. The wire tying machine according to claim 14, wherein the retaining clip is attached to a spool compartment wall part that is comprised in the main body part, such that the retaining clip faces a mounted wire spool.

16. The wire tying machine according to claim 15, wherein the common member at least partly is retained by a body rim that runs along and covers a periphery of the spool compartment wall part.

17. The wire tying machine according to claim 14, wherein the resilient member and the attachment member extend mainly parallel from the common member.

18-22. (canceled)

23. The wire tying machine according to claim 14, wherein the resilient member comprises a handle part that extends away from the rest of the resilient member such that a user is enabled to insert a wire spool, or release an inserted wire spool, by depressing the handle part such that the resilient member clears the rim parts.

24. A method for controlling loading and threading of reinforcement bar tying wire into a wire tying machine that comprises a lid, a trigger, a sensor arrangement and a tying head, wherein the lid is adapted to at least partly cover spool compartment adapted to accommodate a wire spool, wherein the method comprises
determining if the received signal is indicative of that the lid is in a closed position, and if so
setting the wire tying machine in a normal running state such that when the trigger is pressed, the wire tying machine is arranged to feed a free end of wire on the wire spool out from the opening in the tying head such that the wire extends along an arcuate path to encircle reinforcement bars which are to be tied together and is then received back in the tying head, wherein the wire tying machine is arranged to perform a tying procedure such that a knot is formed on the wire;
determining if the received signal is indicative of that the lid is in a closed position, and if so
setting the wire tying machine in a reload state such that when the trigger is pressed, the wire tying machine is arranged to feed the free end of the wire towards the tying head, but without forming the knot on the wire.

25. (canceled)

26. A control unit arrangement adapted to control a function of a trigger comprised in a wire tying machine that also comprises a lid, the trigger, a sensor arrangement and a tying head, wherein the lid is adapted to at least partly cover spool compartment adapted to accommodate a wire spool, characterized in that wherein the control unit arrangement is adapted to control the function of the trigger in dependence of a signal received from the sensor arrangement such that
when the received signal is indicative of that the lid is in a closed position, the wire tying machine is set in a normal running state such that when the trigger is pressed, the wire tying machine is arranged to feed a free end of wire on the wire spool out from the opening in the tying head such that the wire extends along an arcuate path to encircle reinforcement bars which are to be tied together and is then received back in the tying head, wherein the wire tying machine is arranged to perform a tying procedure such that a knot is formed on the wire; and such that
when the received signal is indicative of that the lid is in an opened position, the wire tying machine is set in a reload state such that when the trigger is pressed, the wire tying machine is arranged to feed the free end of the wire towards the tying head, but without forming a the knot on the wire.

27-53. (canceled)
